(19) United States
(12) Patent Application Publication
(10) Pub. No.: US 2013/0067814 A1
(43) Pub. Date: Mar. 21, 2013

(54) HYDROPONIC SYSTEM

(71) Applicants: Britta Riley, Brooklyn, NY (US); Theodore Regan Ullrich, Brooklyn, NY (US)

(72) Inventors: Britta Riley, Brooklyn, NY (US); Theodore Regan Ullrich, Brooklyn, NY (US)

(21) Appl. No.: 13/700,438

(22) PCT Filed: May 27, 2011
(86) PCT No.: PCT/US11/38401

§ 371 Date: Nov. 27, 2012

Related U.S. Application Data
(60) Provisional application No. 61/349,111, filed on May 27, 2010.

(51) Int. Cl. A01G 31/06; A01G 31/02

(52) U.S. Cl. 47/62 R

(57) ABSTRACT

The invention relates to a hydroponic system and method. In various embodiments the hydroponic system and method includes modular plant containers in communication with a fluid reservoir and with one another. Such containers may be hung in vertical columns in window gardens. The containers may be made from low-impact or recycled materials, such as water bottles. The system includes a vertical fluid circuit and an air introduction assembly for supplying water, air and nutrients from the reservoir to the containers.

### CROSS REFERENCE TO RELATED APPLICATIONS

This application claims priority from U.S. Provisional patent application Ser. No. 61/349,111 filed May 27, 2010, which is incorporated herein in its entirety by reference.

### FIELD OF INVENTION

This invention relates to hydroponic systems and methods.

### BACKGROUND

All publications cited herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

Some have argued that to grow at least a portion of one's own food is among the most effective actions an individual can take for the environment, not only because of the food industry's heavy carbon footprint but also because participating in agricultural production cultivates a valuable skill set around sustainability issues. Moreover, many neighborhoods—particularly low income neighborhoods—in cities around the world are considered “food deserts,” meaning little fresh food is easily accessible. Residents tend to consume processed, packaged, and canned food having depleted nutrients. Indeed, there is a need in the art for innovative systems and methods with which inner city dwellers (and others) can grow their own food in an apartment or office window throughout the year. More broadly, there is a need in the art for systems and methods that enable one to grow plants for a variety of purposes in a hydroponic environment; in particular, using light through a window and/or interior lighting as the primary light source, rather than principally relying on outdoor sunlight.

The unique conditions faced by urban dwellers attempting to grow edible plants—which generally require a great deal of water, light, and nutrients—in a small space and in the semi-climate-controlled conditions of an urban window, as opposed to the highly controlled conditions of a hydroponic grow room environment, present a specific set of challenges. Meanwhile, the presence of controlled temperatures indoors year-round and the presence of natural light coming through windows are opportunities. This unique set of conditions have led to the development of the inventive vertical hydroponic system.

### SUMMARY OF THE INVENTION

This invention overcomes many of the problems and difficulties in the prior art and provides the ability to grow plants in a limited space. It does so by providing a series of vertically arranged plant growing containers which are in communication with one another through openings formed in their top and bottom and which are configured to contain plant material. The series of growing containers have, at their bottom, a reservoir of water which is tapped by a supply tube that runs generally vertical upwardly from the reservoir to the upper most plant container. The supply tube in the reservoir receives air pressure at its bottom or through a port on its side from an air line attached to a pump. This arrangement forces water from the reservoir through the supply tube to the upper most plant container from where the water trickles down through the vertical column of containers back to the reservoir. This vertical column of plant containers may be hung either alone or in a series of rows in the window of a building where it is exposed to natural sunlight. It can also be subjected to artificial plant lights to enhance plant growth. Likewise, nutrients can be added to the water to encourage the plant growth.

The principal factors that distinguish this system from other hydroponic systems include, but are not limited to:

1. a vertical column grid orientation that optimizes use of available sunlight coming through a window and that accommodates the specific light, evaporation, and other conditions encountered in the various micro-climates of an indoor residential or commercial window. A hanging configuration may also reduce the occupied footprint of floor space which is often limited in small indoor areas;

2. a fluid circuit in which the movement of the fluid, such as water, has a path that starts and ends in the same point. This is different from the typical arrangement of a trompe and pulser pump;

3. unlike other vertical hydroponic systems used in commercial greenhouse settings, the housings or containers used in this system are of an optimum width and height to provide room, within an opaque container, for the root systems of common vegetable plants without being so wide as to block significant amounts of light from passing through an average sized window. This scale advantage also enables containers to be made of light-weight materials at a lower cost;

4. housings or containers that route nutrients delivered from above while leaving room for optimum root growth and minimizing evaporation as the liquid passes through (“open territory”) from one plant's root system to the next below;

5. the addition of modularity to the vertical stacking of plants such that containers and tubing can be added and/or subtracted at low cost and minimal disruption to the existing system to maximize use;

6. the addition of modularity to plant containers such that optionally one plant can be contained in one container to diminish the risk of disease and pest spreading if one container becomes infected;

7. the addition of modularity to nutrient delivery systems by allowing a different reservoir to be used at the bottom of each column of plants, to enable providing a different nutrient mix to each column of plants such that, for instance, flowering or fruiting plants may be fed their requisite nutrient mix while sitting immediately next to plants in the vegetative stage that require a different nutrient mix;

8. a particular configuration of friction-reducing vertically oriented tubing extending from a bottom reservoir having a depth optimized for airlift performance in relation to evaporation rates, and an orientation of air bubble delivery into the reservoir that will also optimize the depth critical to “airlift” pump delivery of a regular stream of nutrient rich water to high pump “head” heights, using low cost materials and low cost pumps;

9. a particular configuration of tubing assembly that allows the air pump to also function as an aerator for the liquid nutrient solution in the reservoir by periodically blowing back air bubbles into the reservoir, rather than sending them up the air lift tube, thus reducing the frequency of stagnant water and its negative effects;

10. a particular optional orientation of an airlift pump's liquid intake relative to a concave reservoir bottom that acts as a funnel, the combination of which uniquely facilitates the use of organic nutrients in a lower cost system, by keeping organic nutrient sediments in circulation without the need for a powerhead mixer and without the need for a water pump, wherein mechanical parts frequently clog with such sediment;

11. the optional arrangement of containers in a grid-like fashion such that compact fluorescent bulbs (e.g., of proper wattage and/or with a dome) can be used as lighting—supplemental or otherwise—while maintaining an ideal positioning of the lights in relation to the plant(s) to prevent burning while optimizing light delivery distance;

12. a system configuration that makes it possible to use one air pump with multiple outlets to supply air to several different modular column units (e.g., a single aquarium air pump with four outlets might supply the air bubbles that move nutrient liquid through four separate liquid circuit columns). One pump outlet can power one column or a liquid circuit with a 5-7′ head height;

13. unlike vertical wall hydroponic systems, a design that may permit the passage of significant light into the room through a window by keeping the infrastructural elements to a small space footprint within the window;

14. the design of the bottom reservoir such that it can hang from above or sit on a windowsill or floor;

15. the optional inclusion of a transparent material in the bottom reservoir that makes maintenance easier by providing visual feedback on water and nutrient levels, pump performance, and algae growth. This also resists the breakdown of organic nutrients which are sensitive to light; and

16. ease of draining the system through the bottom screw cap of the bottom reservoir, or by easily uncoupling and/or unscrewing the bottom reservoir without disturbing the rest of the system.

A better understanding of the objects, advantages, features, properties and relationships of the invention will be obtained from the following detailed description and accompanying drawings which set forth illustrative embodiments that are indicative of the various ways in which the principles of the invention may be employed.

### BRIEF DESCRIPTION OF THE DRAWINGS

Exemplary embodiments are illustrated in referenced figures. It is intended that the embodiments and figures disclosed herein are to be considered illustrative rather than restrictive.

FIG. 1 depicts an exploded view of a plant with a substrate and basket as may be used with the present invention.

FIG. 2 depicts top and side views of a plant housing or container as used in the present invention.

FIG. 3 depicts top and side views of a bottom or reservoir housing or container in connection with one embodiment of the present invention.

FIG. 4 depicts two plant housings or containers assembled together, each containing a plant, substrate and basket, and supported by a hanging assembly of a chain and coupler and a side view of a coupler.

FIG. 5a depicts cross-sectional, exploded and assembled views of an air introduction mechanism in connection with one embodiment of the present invention.

FIG. 5b depicts a side view of the air introduction mechanism shown in FIG. 5a attached to a bottom or reservoir housing;

FIG. 6a depicts cross-sectional, exploded and assembled view of another embodiment of an air introduction mechanism.

FIG. 6b depicts a side view of a bottom or reservoir housing assembled with the air introduction mechanism of FIG. 6a.

FIG. 7a depicts still another embodiment of an air introduction mechanism shown in cross-sectional, exploded and assembled views.

FIG. 7b depicts the air introduction mechanism of 7a attached to the bottom of a bottom or reservoir housing or container.

FIG. 8 shows a further embodiment of an air introduction mechanism in accordance with the invention.

FIG. 9 is a photograph of an actual air introduction mechanism according to FIG. 8 in place on a reservoir housing or container.

FIG. 10 depicts a still further embodiment of a connection assembly for an air introduction mechanism and supply tubing.

FIG. 11 depicts a cross sectional elevational view of a bottom or reservoir housing in accordance with an embodiment of the present invention.

FIG. 12 depicts an elevational view of a vertical column of containers and fluid circuit in connection with one embodiment of the present invention.

FIG. 13 depicts an elevational view of a bottom or reservoir housing and attached air supply mechanism in accordance with one embodiment of the present invention.

FIG. 14 depicts a side view of a upper plant housing or container assembled with tubing and an external support mechanism, in connection with one embodiment of the present invention.

FIG. 15 is an elevational view of a single vertical column version of an embodiment of the present invention.

FIG. 16 depicts a hydroponic system mounted in an array format with supplemental lighting in a small window space, in accordance with an embodiment of the present invention.

FIG. 17 depicts a configuration of lights for use in connection with a hydroponic system in accordance with an embodiment of the present invention.

FIG. 18 is the hydroponic system of the present invention in a window array and including an alternative reservoir embodiment.

FIG. 19 is a photograph of a two column array of the present hydroponic system.

### DETAILED DESCRIPTION

Although the figures and the following disclosure describes one or more embodiments of this invention, one of ordinary skill in the art would know that the teachings of the disclosure would not be limited to use solely in connection with this disclosure, and instead would appreciate that the teachings of the following disclosure may also apply to other aspects of hydroponic systems.

All references cited herein are incorporated by reference in their entirety as though fully set forth. Unless defined otherwise, technical and scientific terms used herein have the same meaning as commonly understood by one of ordinary skill in the art to which this invention belongs.

One skilled in the art will recognize many methods and materials similar or equivalent to those described herein, which could be used in the practice of the present invention. Indeed, the present invention is in no way limited to the methods and materials described. For purposes of the present invention, the following terms are defined below.

As used herein, “hydroponic” means the cultivation of plants in a nutrient liquid with or without gravel, clay pellets or another supporting medium.

Additional images and multi-lingual fabrication and assembly instructions for the Hydroponic System and method disclosed herein are available at: http://our.windowfarms.org/instructions_dev/, which is incorporated by reference herein.

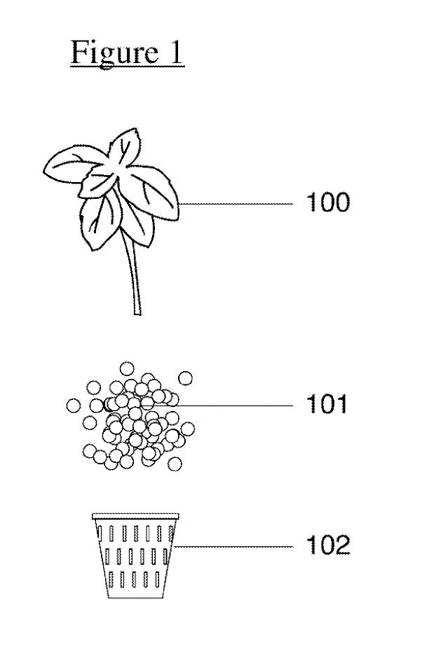

The invention relates to hydroponic systems and methods. As illustrated in FIG. 1, in an embodiment, the invention is to support the growth of plants 100 configured in a substrate 101. As those of skill in the art will readily appreciate, any number of different types of plants 100 and substrates 101 may be used in various embodiments of the invention. Simply by way of example, the plants 100 may be those that yield or can be used for food or they may be ornamental. The substrate 101 can be selected to support the growth of the plant 100 that is to be configured in it. In various embodiments, the substrate 101 can be stones, clay pellets or any number of other materials. The plant 100 and substrate 101 may reside in a basket 102, the configuration of which may be selected based on a variety of factors, including, by way of example, the configuration of other elements of the system with which it is to mechanically interact and/or in which the basket 102 must be configured to fit during assembly, maintenance and/or dis-assembly of the system.

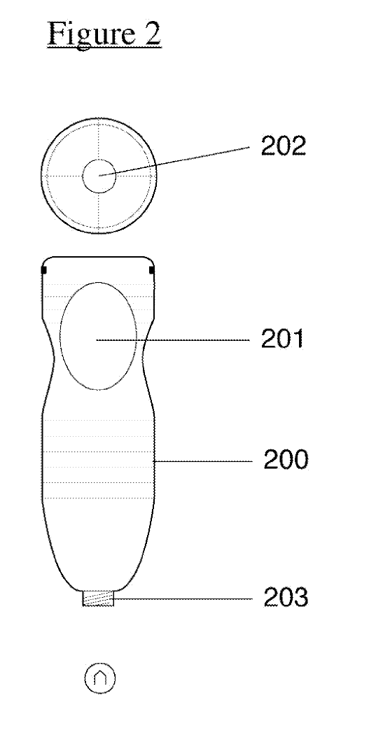

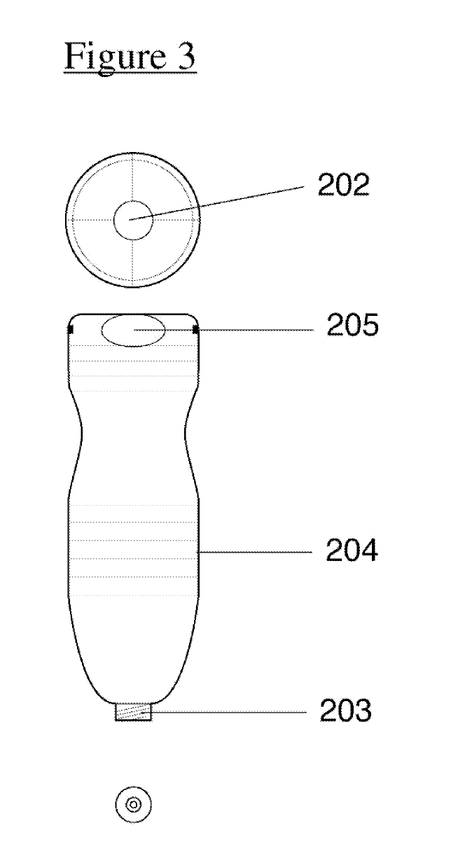

As illustrated in FIG. 2, the invention includes a plant housing or container 200 with an orifice 201 formed in a side near its upper end. The housing plant 200 can be of any number of configurations, and constructed from a wide variety of materials. In the version of the invention illustratively depicted in FIG. 2, the housing 200 is similar to a recycled plastic water bottle, and indeed, the housing may be readily fashioned from such a bottle. The orifice or opening 201 may be cut into the side of housing 200 and is large enough to allow for the plant/basket assembly shown at 100, 101 and 102 to be inserted into and removed from the housing 200. The housing 200 further includes a top opening 202 and a bottom opening 203, each configured to allow water (and optionally, other fluids) to flow into and out of the housing 200, when the system is in operation. The top opening 202 and bottom opening 203 similar in size and configuration or shown in FIG. 3.

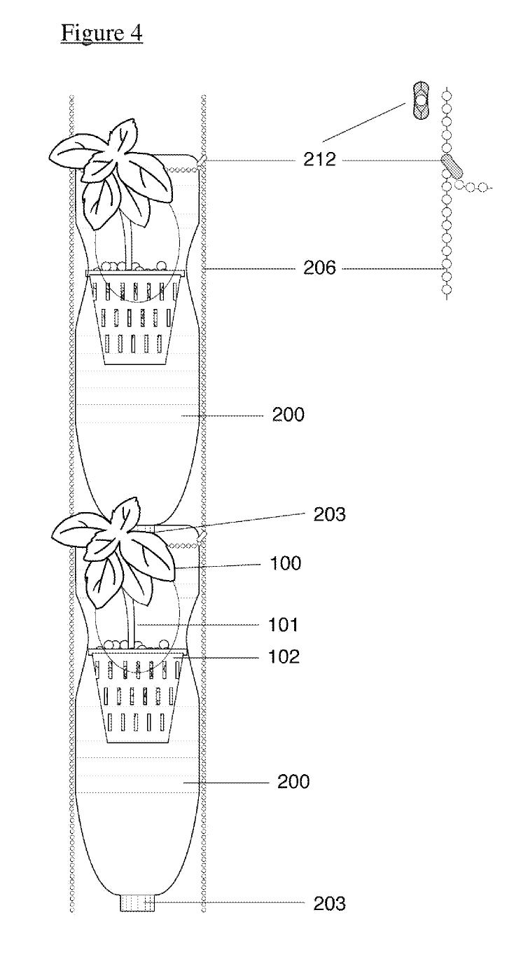

As illustrated in FIG. 4, each plant housing or container 200 is configured such that multiple housings 200 can be assembled together in a vertical orientation, with the bottom opening 203 (the cap end of a water bottle) of an upper housing 200 in mechanical communication (e.g. by insertion) with the top opening 202 of the housing 200 immediately below it such that water may flow (e.g., by virtue of gravitational force) from the upper housing to the lower housing through the mating openings. The housings 200 may be supported in such an orientation through the use of suspension support elements such as a hanging bead chain 206 and coupler attaching to chain 206 and connected to the wall of each housing 200. The suspended system may be secured through an external surface attachment mechanism to an external surface, such that the entire hydroponic system remains suspended in a generally vertical orientation.

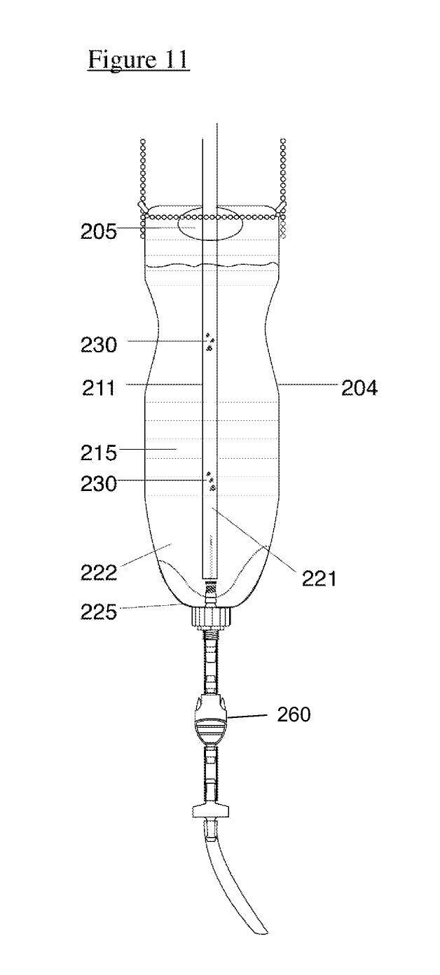

As illustrated in FIGS. 3 and 11, the invention also includes a bottom or reservoir housing or container 204 having a top opening 202, a bottom opening 203 and fluid tube opening 205. The housings 200 and 204 can be of any number of configurations, and constructed from a wide variety of materials. Reservoir housing 204 may be configured to contain a volume of water or other fluid 215 or shown in FIG. 11. Housing 204 may also be a substantially larger vessel than upper plant housings 200 as long as its proportions allow a liquid column depth suitable for the air intake at the bottom of the rigid hollow fluid supply tubing 211 (described below) to be submerged below at least about 4.5″ of water or other fluid 215 (described below) despite evaporation rates at the site.

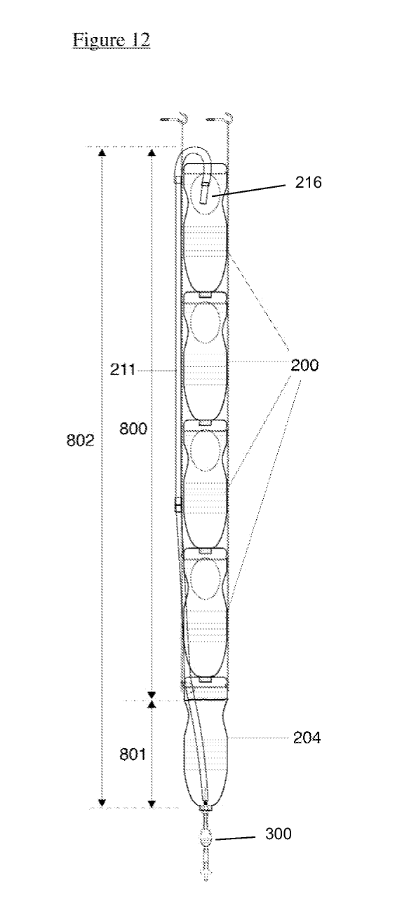

Alternate heights of the water or other fluid 215 may be suitable in alternate embodiments of the invention. As shown in FIG. 12, this vertical configuration of plant containers 200 and reservoir 204 may allow for the delivery of water or other fluid 215 to a head height of more than about 5′ above the level of fluid 215 in reservoir 204 through a rigid, vertically plumbed supply tube 211 without extensive maintenance and refilling regimens, which may be beneficial in connection with certain embodiments of the invention. The tube hole 205 in reservoir housing 204 is configured to allow for fluid supply tubing 211 to pass upwardly therethrough. Through supply tube 211 the volume of water or other fluid 215 in reservoir 204 is kept in fluid communication throughout the system. The tubing 211 extends to and into the uppermost plant housing 200 and carries fluid to that uppermost plant housing. As a result, water (and optionally, other fluids) then flows downwardly from the uppermost plant housing through each plant housing, into the bottom housing 204 when the system is in operation. The bottom or reservoir housing 204 may also include a bottom opening 203′, configured to mate with an air introduction mechanism 300 (described below).

The housings or containers shown in FIGS. 2 and 4 may be custom produced to have a more opaque outer surface so as to reduce the exposure to light which in turn breaks down nutrients. Such custom produced largely opaque containers may have some transparent parts, particularly in reservoir housing 204, to indicate the water level for maintenance purposes.

As illustrated in FIG. 12, multiple plant housings 200 may be connected in a generally vertical orientation above bottom reservoir housing 204. The plant housings 200 may be supported in such an orientation through the use of support elements, which, as illustrated in FIG. 4 maybe constructed from bead chain 206 in combination with bead chain couplers 212. In this case, the couplers 212 connect the support chain 206 with the housings 200 through holes configured in the housings 200. Those skilled in the art will readily appreciate any number of other flexible systems and mechanisms that may be used to effectuate a generally vertical support and attachment of multiple housings 200. Alternatively, rigid standalone support structures may be used for this purpose, as will be readily appreciated by those of skill in the art.

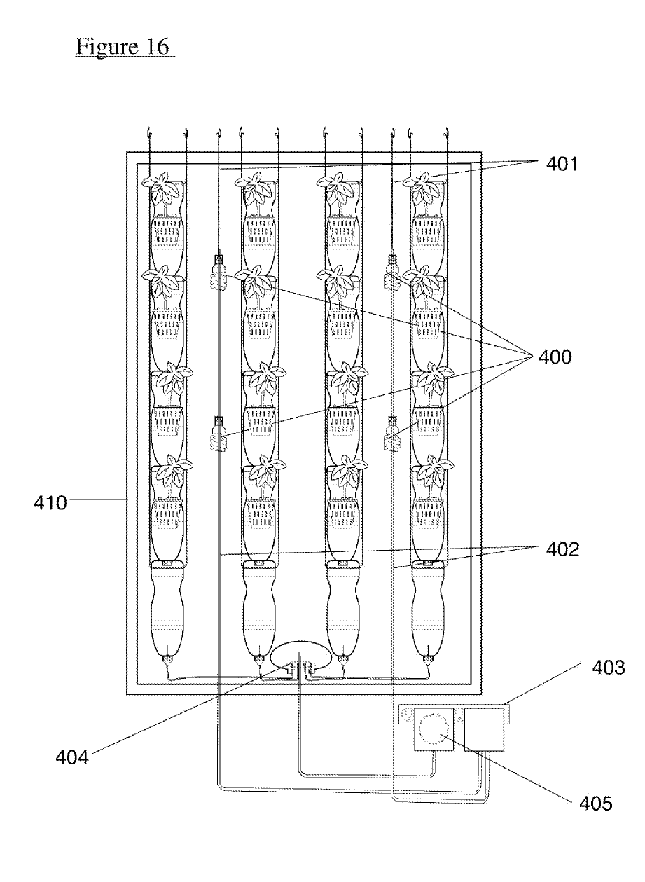

In connection with another embodiment of the invention, shown in FIG. 16, multiple plant housings 200 above bottom reservoir housing 204 and similar elements of the system can be arranged as a series of vertical columns in an array suitable for the spatial restrictions of a typical apartment or office window. This may accommodate natural light penetrating in one direction. Prior vertical hydroponic systems have generally used an array of plants distributed in a spiral fashion around a column, to be used outdoors where light is more likely to hit the system from several different angles. Thus these other systems take up a great deal more space and will not fit as many plants under suitable growing conditions within the vertical space of a window as the present invention. The modularity of the present design allows the system to be scaled with relatively low cost and low disruption to the existing system.

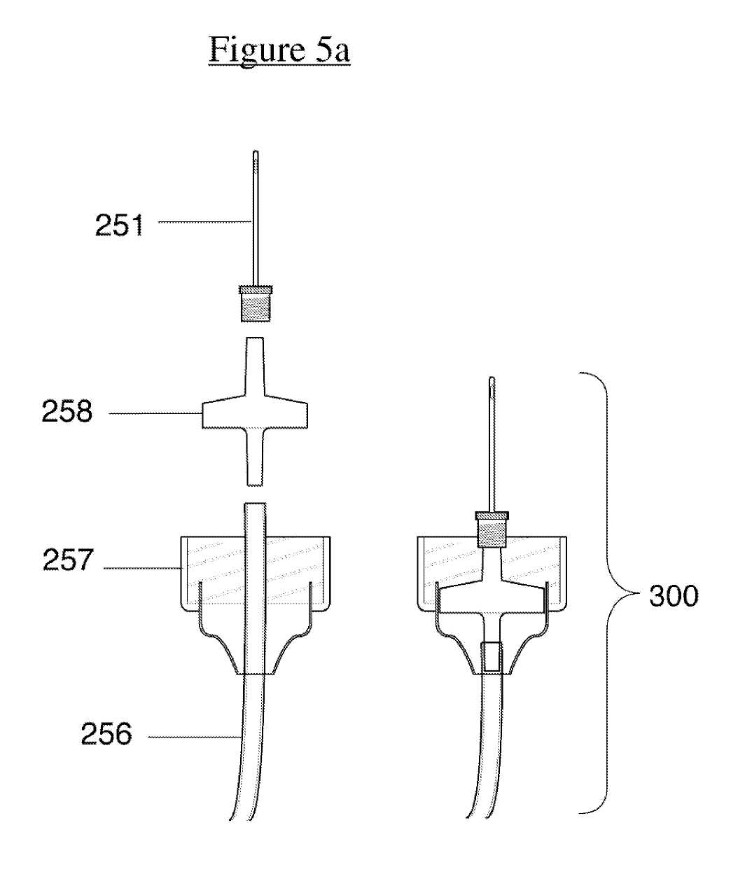

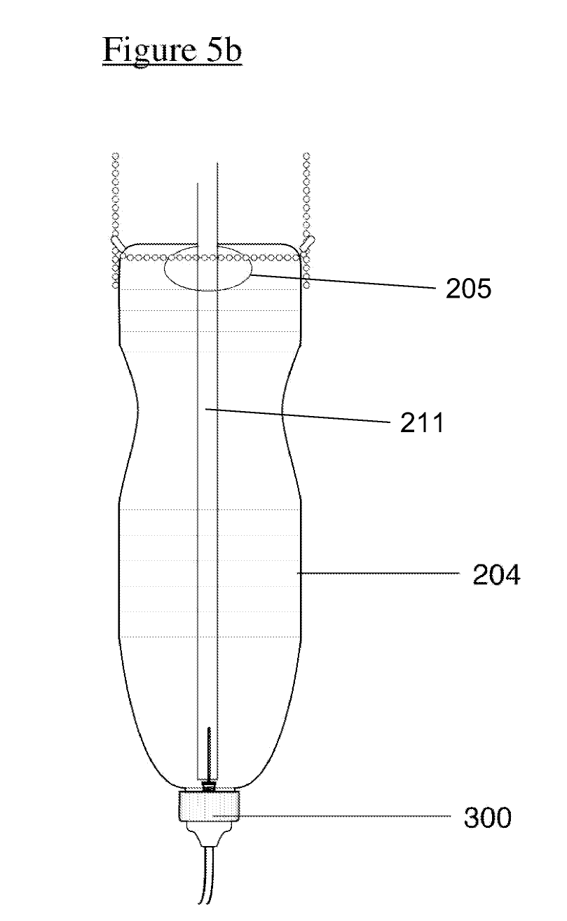

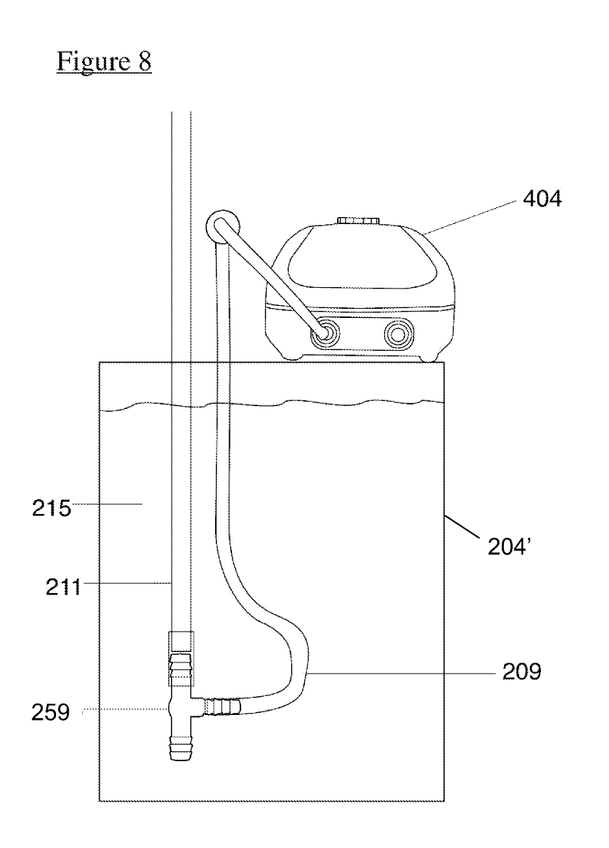

As illustrated in FIGS. 5 through 7 the invention also includes air introduction mechanism, such as shown at 300 in FIG. 5, which is used to continually introduce air from an external source, such as a conventional aquarium pump 404, shown in FIG. 8, through a hose 209 and into the volume of water or other fluid 215 contained in the bottom reservoir housing 204. In all embodiments, the invention takes advantage of the Venturi Effect to move water upwards from reservoir 204 through tubing 211 to the uppermost plant housing 200, by arranging parts to form various variations of an Aspirator mechanism created by attachment of the air introduction mechanism. Any other suitable gas may be substituted for air.

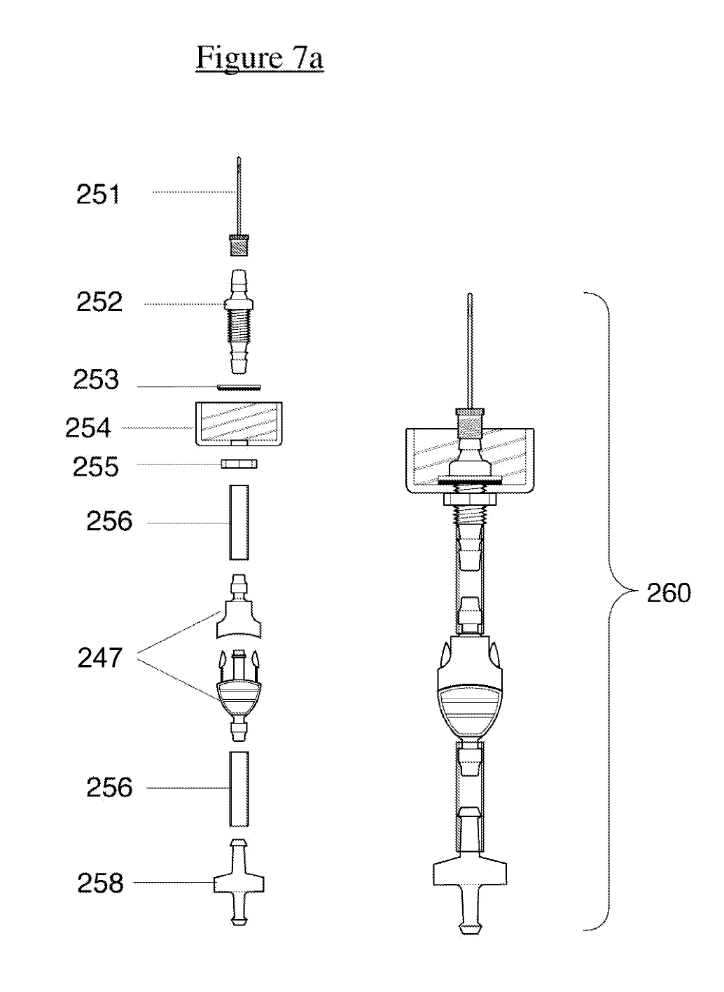

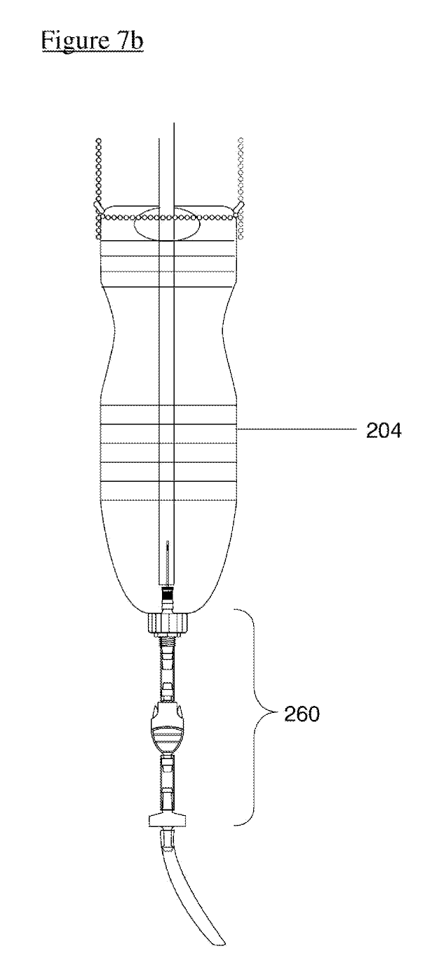

As shown in FIG. 16 it may be possible to use a single air pump 405 with manifold 404 having multiple outlets to simultaneously induce fluid to flow from the reservoir containers 204 of multiple vertical columns of housings 200. For example, as illustrated in FIG. 11, air bubbles 221 travel from the air introduction mechanism, in this case 260 from FIG. 7, to the needle outlet 251 which is inserted into the open bottom of tubing 211, thereby creating a vacuum and forcing small quantities of the water or other fluid 215 contained in the reservoir housing 204 through the tubing 211 to a location substantially at or near the top of upper plant opening 216 in the column (FIG. 12), where it may be released to flow into the first of the one or more plant/basket containers 200 forming the system. The water or other fluid may thereafter flow through the one or more housings 200 and one or more plant/basket assemblies (a portion of the water or other fluid having been consumed by the one or more plants and/or lost from the system through evaporation), ultimately returning to the volume of water or other fluid 215 contained in the bottom housing 204. Thus, a closed circuit of fluid flow is created.

Referring again to FIG. 5, the air introduction mechanism may include an inflation needle 251, which, in the illustrated embodiment, is a metal needle similar to that which one would use on a bicycle tire pump to inflate a sports ball. The inflation needle 251 may be affixed to a one-way air valve 258 and connected through flexible air tubing, then situated firmly in a ‘Sports Cap’ screw cap 257, then attached securely to a threaded cap of over bottom opening 203 on the bottom housing 204.

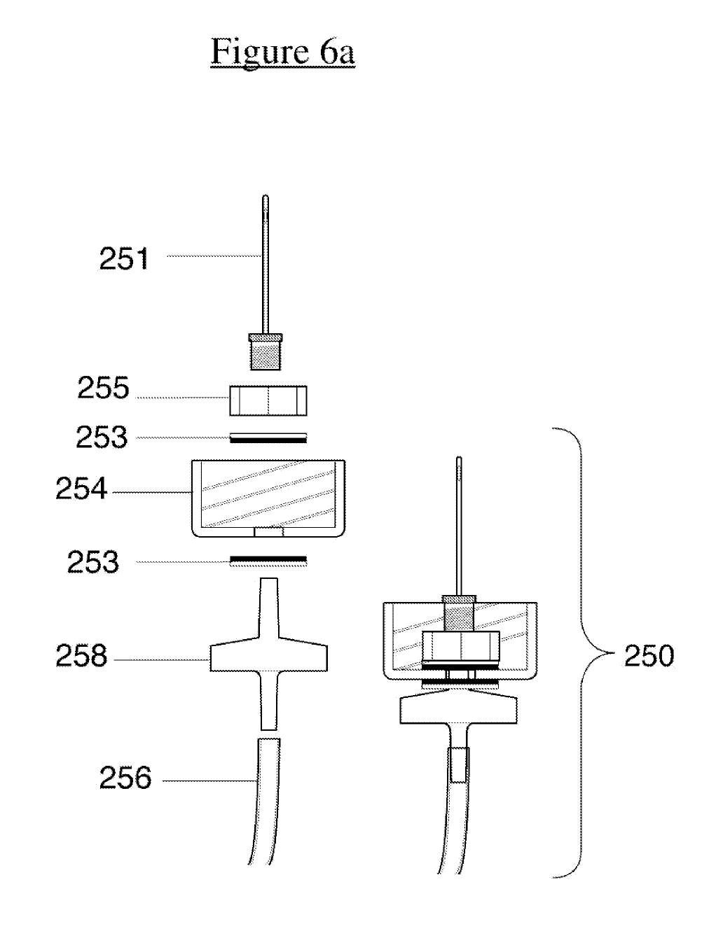

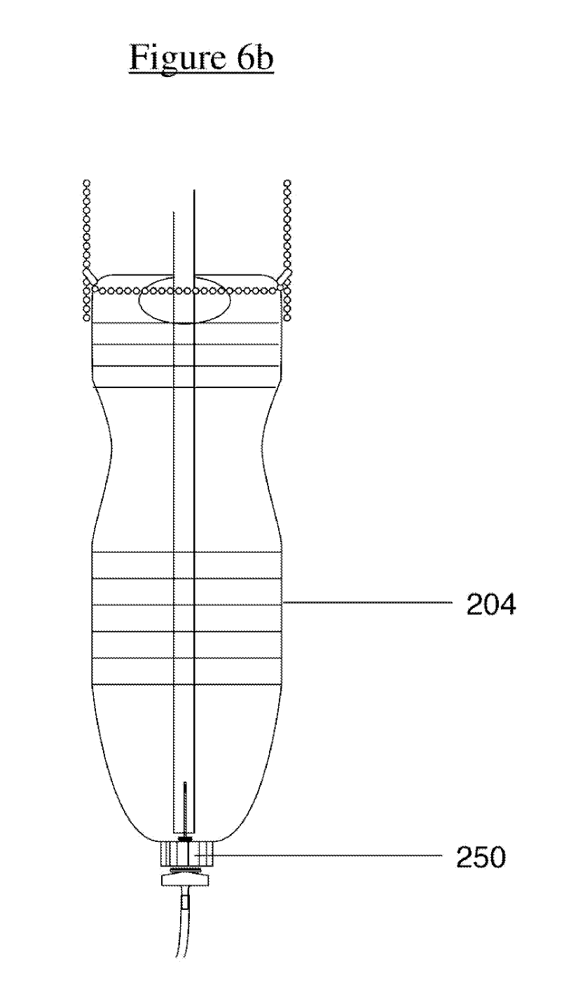

Referring to FIG. 6, in an alternative embodiment, the air or gas introduction mechanism may instead include the metal inflation needle 251 attached to a threaded nut 255, bonded sealing washer 253, bottle cap with drilled hole 254, a second bonded sealing washer 253, a one-way air valve 258, and air tube 256.

Referring to FIG. 7, in a still further embodiment, the air introduction mechanism 260 may instead include the metal inflation needle 251, a threaded plastic bulkhead 252, a bonded sealing washer 253, bottle cap with drilled hole 254, a plastic nut for the plastic bulkhead 255, a small length of air line tube used as a connector 256, a quick-release valve 247 for each of draining and assembly, another piece of air line tube used as a connector 256, and a one-way air valve 258.

In FIG. 5, 6 or 7 once the bottom cap assembly is tightly sealed to the bottom reservoir 204, the water tube may be positioned over the top of the metal needle assembly, creating a overlap distance necessary for optimum upward water flow between the metal inflation needle's tip 251 and the bottom of the air tube 211 but not sealing the bottom of tube 211.

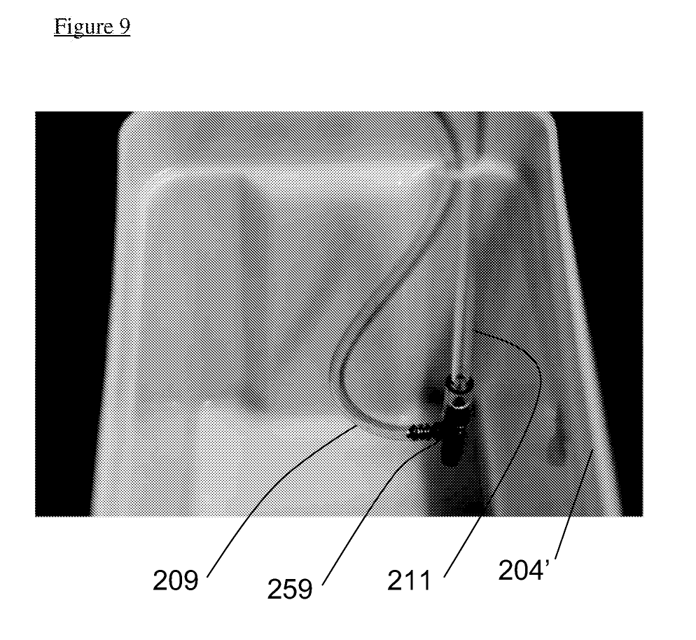

In FIG. 8, an alternative method for air introduction is shown. This configuration is not dependent on a hanging bottom reservoir housing 204, but instead is better suited for a type of bottom housing 204′ that sits on a floor or a ledge, and allows penetration from the top instead of the bottom. The air introduction mechanism takes advantage of the same Venturi effect however, by way of, for example, a T-valve 259, with the air being introduced approximately 1″ above the bottom opening 219 where the water flows in. FIG. 9 shows a photograph of the configuration embodied in FIG. 8 in use.

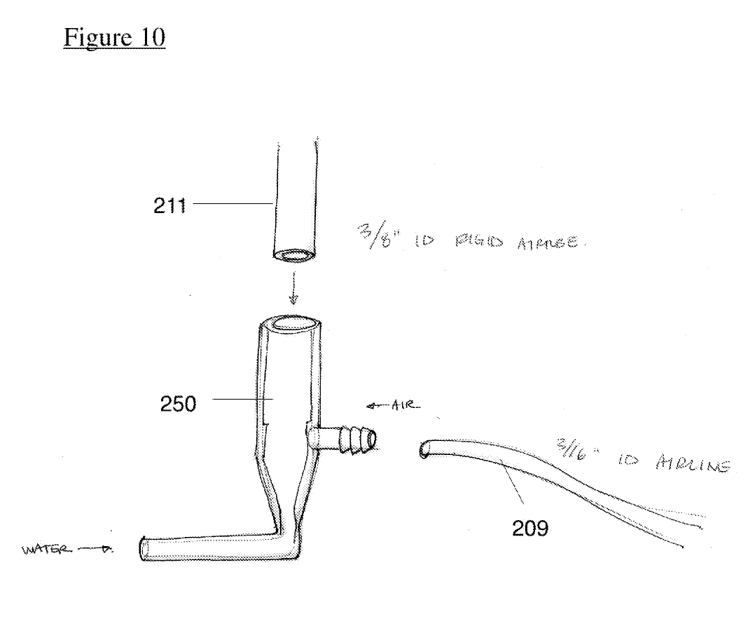

The water flow performance accomplished in FIG. 8 may be increased by taking advantage of known variations of an aspirator mechanism, including stacked aspirators (not shown), in which two or more aspirator mechanisms 250 are attached vertically at the base of the water tube 211 to circulate fluid 215 and sediment particles 230 within the system. As shown in FIG. 10, a manipulated form of the aspirator mechanism 250 in which the air supply leg 209 is bent at a right angle can help maintain a proper position of itself and the water tube 211 during system use. The orientation of entry and exit holes with respect to a concave reservoir surface and plant containers may allow the water tube to stand plumb more reliably.

As illustrated in FIG. 11, the concave funnel shape 225 of the bottom housing 204 may aid in the movement of beneficial sediment particles 230 from organic nutrient buildup/sludge in the bottom of reservoir 204 towards the intake of the tube 211, so as to promote their re-circulation in the liquid 215 carried up through tubing 211 and throughout the system for the benefit of the plants 100.

Referring again to FIG. 11, the system may also accommodate the periodic presence of air bubbles 222 that do not flow upward through the tube 211, but instead bubble into the liquid 215 contained in the bottom housing 204, creating an aeration effect on that liquid 215. Other systems rely on a second pump in order to accomplish this beneficial aeration effect.

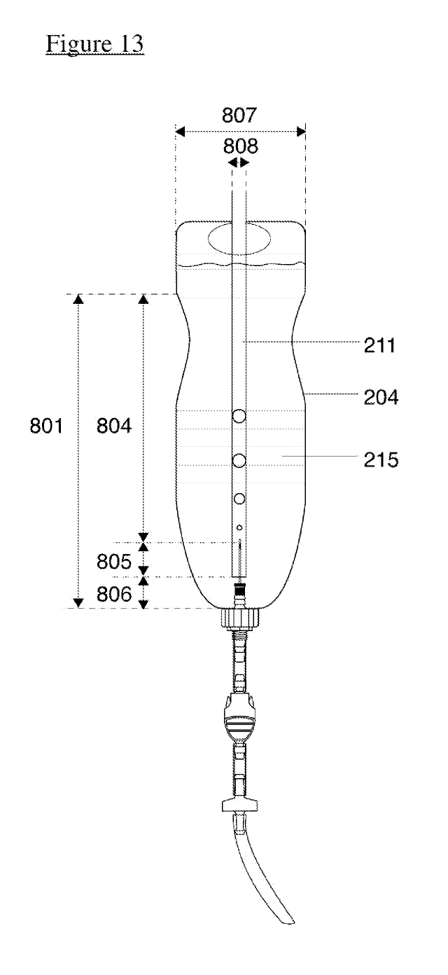

As illustrated in FIG. 12, a certain relationship has been found between the maximum water pumping head-height 802, the fluid column height 801 in the bottom reservoir 204, the physical characteristics of the water tube 211, and further variables inside the bottom reservoir 204 (described below). An optimal head height distance 802 of greater than 5 feet can be achieved by using a water tube 211 with a smooth inner wall and inner diameter 808 (See FIG. 13) of 3/16″, and maintaining tubing 211 in an approximately straight and plumb vertical alignment. Under these circumstances, an algebraic relationship has been discovered where the maximum water pumping head-height 802 equals ten times the fluid column height 801 in the reservoir 204. As the fluid column height 801 reduces through consumption by the plants and evaporation, so does the maximum water pumping head-height 802 in direct proportion.

As illustrated in FIG. 13, a certain relationship has also been found between the maximum water pumping head-height 802 in FIG. 12, the fluid column height 801 in the bottom reservoir 204, the base gap distance 806 between the bottom of the reservoir 204 and the entry at the bottom of the tube 211, the penetration distance 805 of the inflation needle into the tube 211, the submersion distance 804 of the tip of the water needle beneath the fluid column height 801, and the inner diameter 808 of the tube 211. Under the circumstances when the inner diameter 808 of the water tube 211 is 3/16″, and the penetration distance 805 of the metal inflation needle (and therefore the origin of air bubbles) into the tube 211 is between 1″ and 1.5″, and the base gap distance 806 is minimized to less than 1″, and the fluid column height 801 is greater than 4.5″, a maximum water pumping head-height 802 can be achieved of at least 5 feet.

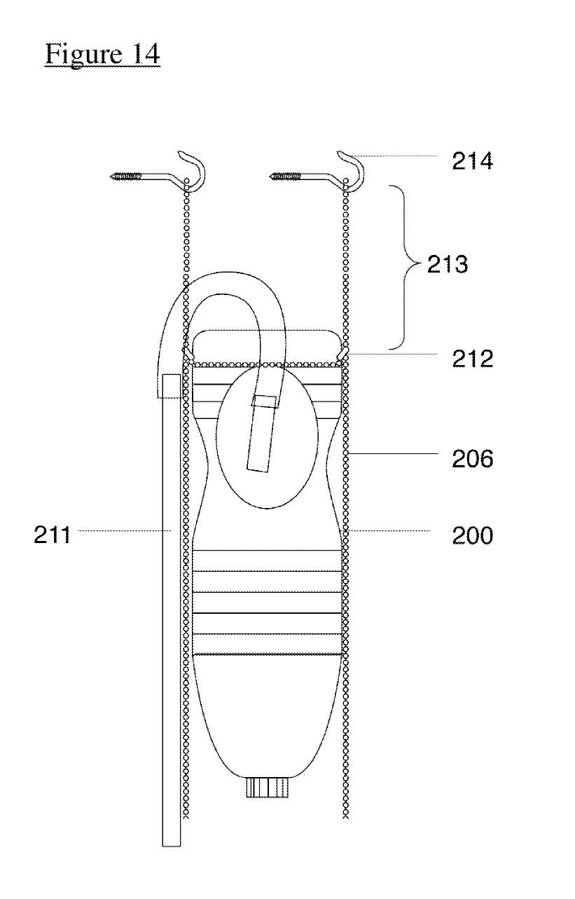

As illustrated in FIG. 14, the system may be secured through an external surface attachment mechanism 213 including chain 26, hooks 214 mounted in a window frame and clips or couplers 212 attaching the chain 206 to housing 200, such that the system remains supported in a generally vertical orientation.

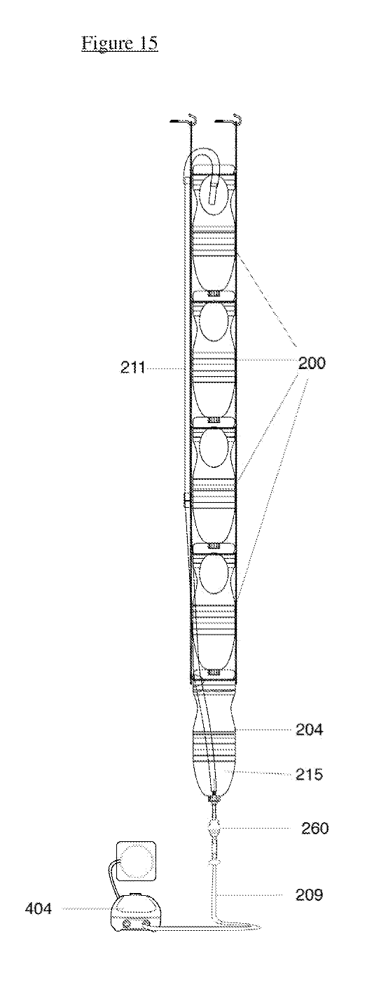

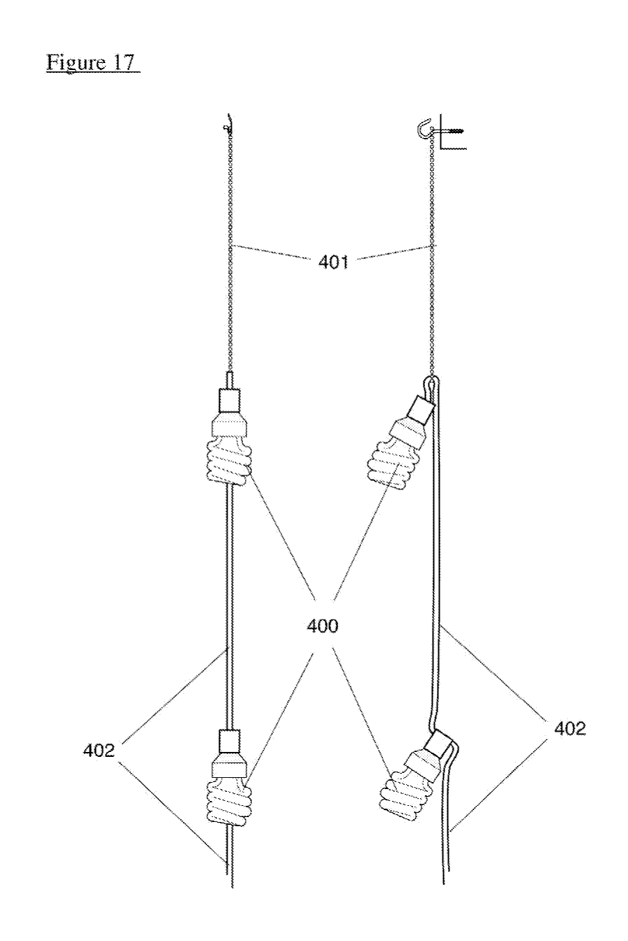

A fully-assembled single column embodiment of the present invention is depicted in FIG. 15. Another embodiment of the fully-assembled system of the present invention configured in an array (a series of columns) is depicted in FIG. 16. An assembly of lights 400 (e.g., compact fluorescent lights) to deliver light to the plants is depicted in FIG. 17, and multiples of these assemblies are included in the version of the system depicted in FIG. 16. The lights 400 may be hung from a mechanism 401 that provides vertical support, such as a chain, and may be in electric communication by wiring 402 to a power source 403. The system depicted in FIG. 16 may also include a secondary power source, which may be in independent electronic communication with timers 405, 406 to control their operation. The light delivered by the lights 400 may be “supplemental” in the sense that they supplement sunlight coming through the window 10 in which the system is positioned.

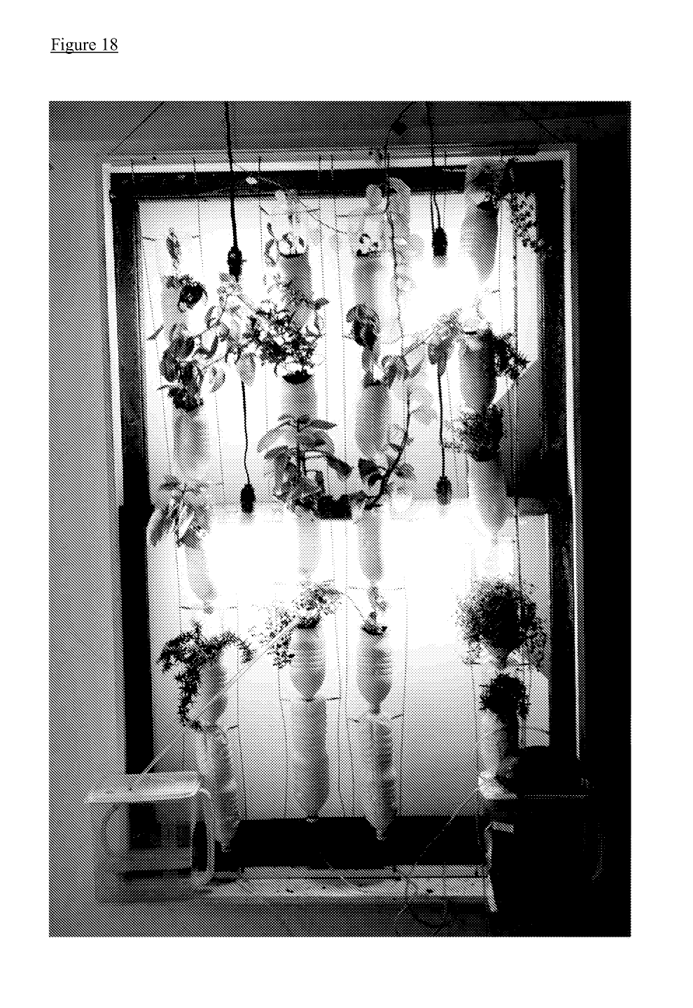

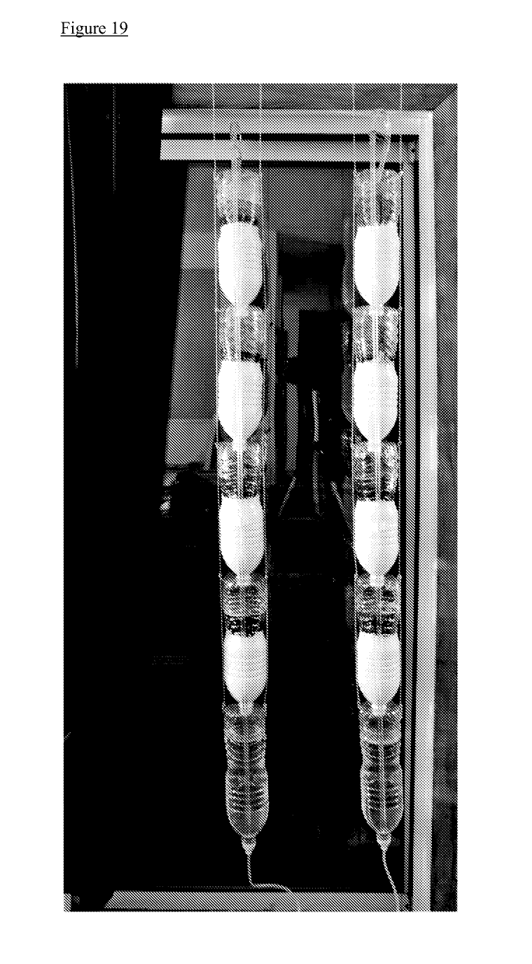

FIG. 18 (photograph) shows one of many possible alternative arrangements of a grid of compact fluorescent lights in conjunction with which this inventive system's design may be used to optimize plant growth. FIGS. 19 and 20 (photographs) show arrangements of the hydroponic system of the present invention in operation.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s).

1. A hydroponic system comprising:
a reservoir housing configured to contain a volume of fluid;
at least one plant housing located vertically above the reservoir housing and adapted to contain and support a plant and having inlet and outlet openings to allow fluid to pass through said plant housing;
tubing configured to convey fluid from the reservoir housing to said at least one plant housing at a point above the plant; and
a gas supply device in communication with said tubing within said reservoir to induce the flow of fluid within the system.

2. A hydroponic system comprising a plurality of vertically arranged containers, said plurality of vertically arranged containers including a bottom container adapted to hold a volume of fluid and at least one upper plant container adapted to hold a plant, said upper plant container positioned above said bottom container and in communication with said bottom container, fluid supply tubing extending from said bottom container to said at least one upper container for the purpose of conveying fluid from said bottom container to said at least one upper container and, an air supply device in communication with said supply tubing within said bottom container for the purpose of initiating fluid transfer through said fluid supply tubing to said at least one upper container.

3. The hydroponic system of claim 2 further including middle plant containers adapted to hold plants and vertically positioned between said bottom container and said at least one upper container, each of said middle containers being configured with openings at its top and its bottom to allow transmission of fluid there through.

4. A hydroponic system comprising an array of vertically arranged containers positioned in side by side relationship for growing vegetation in limited space said array comprising:
a first column of containers having a bottom container and at least one upper container in communication with said bottom container, wherein said at least one upper container also contains a plant;
at least one second column of containers adjacent to said first column of containers, said at least one second column of containers including a second bottom container and at least one second upper container in communication with said second bottom container, wherein said second upper container is adapted to contain a plant;
a first fluid line in said first column, extending between said bottom container and said at least one upper container to supply fluid to said upper container, a second fluid line in said at least one second column extending between said second bottom container and said second upper container to supply fluid to said second upper container; and
a first air supply line in communication with the said first fluid line within said bottom container and a second air supply line in communication with said second fluid line in said second bottom container, and pump for supplying air pressure to said first and second air supply lines and thereby causing fluid to flow from said bottom container and said second bottom container to said first upper container and said second upper container in set second column, respectively.

5. The hydroponic system of claim 4 further including additional vertically arranged columns of containers, each column having a bottom container and at least one upper container, each of said additional columns having a fluid supply line in communication through an air supply line with said air supply device.

6. The hydroponic system of claim 4 which wherein said first column of containers and said second column of containers are hung on a first and second series of chains and thereby supported in a generally vertical orientation.

7. The hydroponic system of claim 4 wherein all or portions of each plant container is formed from an opaque material.

8. The hydroponic system of claim 4 wherein each of at least said upper containers are made from recycled water bottles.

9. The hydroponic system of claim 4 wherein said pump supplies air bubbles to each of said bottom containers, thus reducing the frequency of stagnant water and lack of oxygen.

10. The hydroponic system of claim 4 wherein each bottom container has a generally concave bottom surface that acts as a funnel to keep organic nutrients and sediments in circulation without the need for a power mixer.

11. The hydroponic system of claim 4 wherein artificial lighting is placed adjacent said first and second columns to maximize growth of plants.

12. A hydroponic system comprised of a series of connected plant containing containers vertically arranged above a reservoir container, said reservoir container adapted to hold a volume of fluid, a fluid distributor assembly including hollow tubing having an open end submerged in fluid in said reservoir, said tubing extending upwardly to an upper plant containing container and, an air supply assembly including an air pump and an air line extending from said air pump to said lower end of such hollow tubing, said air supply inducing said fluid in said reservoir to flow upwardly through said tubing to said upper plant container.

13. The system of claim 12 wherein said air line is inserted into said hollow tubing an optimum distance above an open end of said tubing within said reservoir.

14. The system of claim 13 wherein said optimum distance is between one and one and one/half inches.

15. The system of claim 13 wherein said air line terminates in a needle valve which is inserted into an open lower end of said fluid supply tubing.

16. The system of claim 13 wherein said air line intersects said hollow tubing with an aspirator.

17. The system of claim 15 wherein the distance from the open lower end of said fluid supply tubing to the bottom of the reservoir is less than one inch and said needle valve is inserted less than 1.5 inches into said lower end of said fluid supply tubing and said fluid supply tubing is about 3/16 inches in diameter.

18. The system of claim 12 wherein said fluid level in said reservoir is optimally maintained at about 10% of the vertical distance from the reservoir container to the upper plant container.
